(19) United States
(12) Patent Application Publication
(10) Pub. No.: US 2014/0372420 A1
(43) Pub. Date: Dec. 18, 2014

(54) Systems and Methods for Providing Search Results for Mobile Businesses

(71) Applicant: Google Inc., Mountain View, CA (US)

(72) Inventor: Mitchell Warren Slep, San Francisco, CA (US)

(73) Assignee: Google Inc., Mountain View, CA (US)

(21) Appl. No.: 13/722,363

(22) Filed: Dec. 20, 2012

(51) Int. Cl. G06F 17/30

(52) U.S. Cl. CPC G06F 17/30864
USPC 707/724

(57) ABSTRACT

Embodiments include a computer-implemented method that includes receiving mobile business location information indicative of a geographic location of a mobile business, receiving a search request, identifying a set of search results responsive to the search request, the set of search results including a search result corresponding to the mobile business, identifying a current geographic location of the mobile business based at least in part on the mobile business location information, ranking the set of search results based at least in part on the current geographic location associated with the mobile business to generate a set of ranked search results, and providing the set of ranked search results for display.

### BACKGROUND OF THE INVENTION

1. Field of the Invention

Embodiments of this invention relate generally to search industries and, more particularly, to special purpose machines, systems, methods and computer instructions for providing search results relating to mobile entities.

2. Description of the Related Art

The Internet provides access to a large number of resources, including, for example, webpages, maps, articles, files, and the like. To locate resources on the Internet, persons often employ Internet searches or similar resource locating services. For example, a person may visit an Internet search website and submit search query for “ice cream” in hopes of locating nearby businesses that serve ice cream. Search results are typically displayed in a ranked listing based at least in part on their relevance to the search query, and may be accompanied by a map illustrating locations associated with at least some of the search results. For example, search results for the search query “ice cream” may include a listing of nearby ice cream shops, and a map having markers at the locations of the ice cream shops.

Unfortunately, the search results provided to the user may only correspond to brick-and-mortar businesses having a fixed location, and may not include results for “mobile” businesses (i.e., business that have a variable location). For example, the search results for the search query “ice cream” may include search results for brick-and-mortar ice-cream shops near the user, but may not include a search result for an ice cream truck that is located even closer to the user. Thus, the search results may not provide a complete listing of results that are of interest to the user.

### SUMMARY OF THE INVENTION

Various embodiments of methods and apparatus for identifying and providing search results relating to mobile entities are provided herein. In some embodiments, provided is a computer-implemented method that includes receiving mobile business location information indicative of a geographic location of a mobile business, receiving a search request, identifying a set of search results responsive to the search request, the set of search results including a search result corresponding to the mobile business, identifying a current geographic location of the mobile business based at least in part on the mobile business location information, ranking the set of search results based at least in part on the current geographic location associated with the mobile business to generate a set of ranked search results, and providing the set of ranked search results for display.

In some embodiments, provided is a system including one or more memories storing instructions and one or more processors coupled to the one or more memories and configured to execute the instructions stored thereon to perform the following steps: receiving mobile business location information indicative of a geographic location of a mobile business, receiving a search request, identifying a set of search results responsive to the search request, the set of search results including a search result corresponding to the mobile business, identifying a current geographic location of the mobile business based at least in part on the mobile business location information, ranking the set of search results based at least in part on the current geographic location associated with the mobile business to generate a set of ranked search results, and providing the set of ranked search results for display.

In some embodiments, provided is a non-transitory computer readable medium comprising program instructions stored thereon that are executable by a processor to cause the following steps: receiving mobile business location information indicative of a geographic location of a mobile business, receiving a search request, identifying a set of search results responsive to the search request, the set of search results including a search result corresponding to the mobile business, identifying a current geographic location of the mobile business based at least in part on the mobile business location information, ranking the set of search results based at least in part on the current geographic location associated with the mobile business to generate a set of ranked search results, and providing the set of ranked search results for display.

### BRIEF DESCRIPTION OF THE DRAWINGS

FIG. 1 is a flowchart that illustrates a method of updating mobile business location information in accordance with one or more embodiments of the present invention.

FIG. 2 is a table that illustrates an entity database storing mobile business location information in accordance with one more embodiments of the present invention.

FIG. 3 is a flowchart that illustrates a method of servicing a search query in accordance with one or more embodiments of the present invention.

FIGS. 4A and 4B are tables that illustrate ranked sets of search results in accordance with one more embodiments of the present invention.

FIG. 5 illustrates a search results webpage in accordance with one or more embodiments of the present invention.

FIG. 6 is a block diagram that illustrates a search query environment in accordance with one or more embodiments of the present invention.

FIG. 7 is a block diagram that illustrates an exemplary computer system in accordance with one or more embodiments of the present invention.

### DETAILED DESCRIPTION

As discussed in more detail below, provided are systems and methods for providing search results relating to mobile entities. Although certain embodiments are described with regard to mobile businesses for the purpose of illustration, it will be appreciated that the same or similar techniques may be employed for any variety of mobile entities (i.e., entities that are associated with a variable geographic location).

An “Internet search” or “web search” may include a search that is employed by a user to locate resources on the Internet. An Internet search may include, for example, a free-text web search, a map-based web search or the like. A free-text web search may include employing user submitted search criteria, such as a text search string or similar query, to search the Internet for resources that match or are otherwise related thereto. A map-based web search may include may include employing user submitted search criteria to search the Internet for resources relating to places (e.g., locations, business, landmarks, points of interest, etc.) that match or are otherwise related thereto. The search results that are identified are typically displayed to the user in a list, a map or similar presentation format. For example, the user may be presented with an ordered listing of a given number of the highest ranked search results of the set of search results (e.g., including links to webpages, maps, or other resources that correspond to the highest ranked search results). Although certain embodiments are described herein with regard to map-based searches for the purpose of illustration, it will be appreciated that the same or similar techniques may be provided for any variety of searches, such as free-text, universal searches (i.e., searches that combine results from a plurality of different types of searches, such as, map-based searches and so forth), and the like.

As described herein, certain embodiments include receiving mobile business location information (e.g., location information indicative of the dynamic/variable geographic location of a mobile business) and providing search results that are based on a location of the mobile business at or near the time of a corresponding search query. For example, a mobile business operator may provide mobile business location information for their business, which is stored in a database, and, upon receiving a search query for which the mobile business is identified as a search result, the mobile business location information may be used to determine a location of the mobile business at or near the time of the search and a ranking of the search result corresponding to the mobile business may be adjusted (e.g., boosted/lowered) based at least in part on the determined location. Such a technique may enable search results to reflect the location of mobile businesses at or near the time of a search query. For example, when a user submits a search for “ice cream” and an ice cream truck mobile business is not in the vicinity of the user, the result for the ice cream truck may not be ranked high enough to be listed in the search results that are displayed to the user. However, when the user submits the search for “ice cream” and the ice cream truck mobile business is in the vicinity of the user, the result for the ice cream truck may be ranked high enough to be listed in the search results that are displayed to the user. Thus, the user may be provided with a complete listing of search results, including mobile businesses that are determined to be located near the user at the time of the search.

In some embodiments, in an effort to aid the user in interpreting the search results, the displayed search results may include an indication that a result corresponds to a mobile business. For example, a search result for the ice cream truck may be accompanied by an icon (e.g., an icon depicting a car) that is indicative of the search result being associated with a mobile business. As a further example, a map-based search result for the ice cream truck may include a map having a marker (e.g., an icon depicting a car) at a current location of the ice cream truck and a path indicative of the expected route for the ice cream truck and/or markers that identify locations along the route and expected times of arrival of the mobile business at those locations. Search results associated with fixed locations, such as business having brick-and-mortar locations, may be associated with different identifiers, such as a pin style marker, thereby enabling the user to quickly decipher which results correspond to mobile businesses and which search results do not.

The mobile business location information for a mobile business may be obtained in a variety of manners. For example, the mobile business location information for a mobile business may be obtained via tracking of the mobile business (e.g., real-time tracking of the location of a mobile device carried on the ice cream truck), via manual location updates (e.g., via regular social network updates, such social status updates, such as microblog messages (e.g., “Tweets”), location messages (e.g., “check-ins”) or the like, submitted by the ice cream truck driver using Twitter, Google Latitude or a similar service), or via a predefined route (e.g., a route/schedule that indicates where the ice cream truck will be and when).

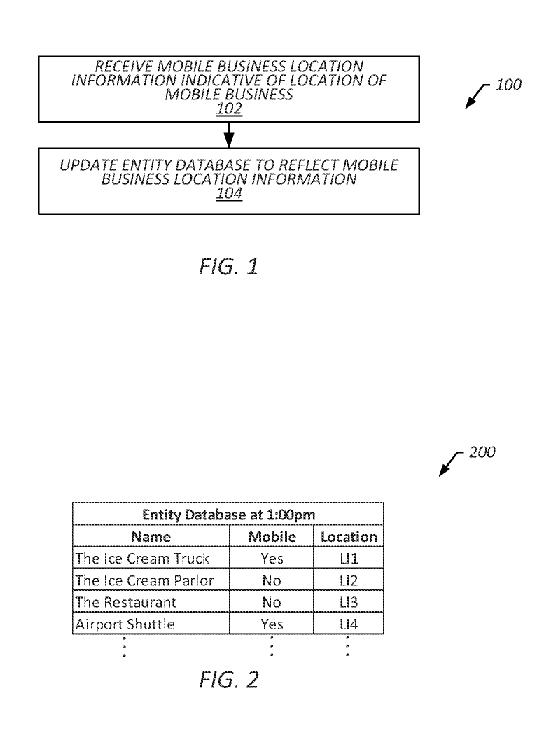

FIG. 1 is a flowchart that illustrates a method 100 of updating mobile business location information in accordance with one or more embodiments of the present invention. Method 100 may generally include receiving mobile business location information, such as route information, dynamic location updates, or the like, that is indicative of a location of a mobile business and updating an entity database (or similar data repository) to reflect the mobile business location information. Although certain embodiments are described with respect to receiving and updating location information for a single business for the purpose of illustration, it will be appreciated that such techniques can be used to receive an update location for any number of mobile businesses. That is method 100 may be repeated for any number of updates for any number of mobile businesses.

Method 100 may include receiving mobile business location information indicative of the location of a mobile business (block 102). In some embodiments, the mobile business location information is received by a search provider from a mobile business operator, and may be employed to determine a location of the mobile business at various times of the day. For example, an operator of a mobile business, such as an ice cream truck driver, may submit, to a search provider, information about the location of their mobile business and various times throughout the day, and the search provider may store the mobile business location information for use in determining a location of the mobile business at or near the time of a search query that is later submitted by a user.

In some embodiments, receiving mobile business location information indicative of the location of a mobile business includes receiving route information indicative of the expected location of mobile business. For example, where an ice cream truck has a regular route that traverses a neighborhood, the ice cream truck operator may specify route information indicative where the ice cream truck will be and when. The route information may include one or more locations along a route and times when it is expected that the mobile business will be at those locations. For example, the operator of the ice cream truck may specify route information indicating that the ice cream truck will be at 100 Main St. at 1:15 pm, at 200 Main St. at 1:20 pm, at 1100 2^{nd} St. at 1:25 pm, and so forth. Accordingly, the route information may include one or more locations along a route, and a schedule for the mobile business arriving at those locations.

In some embodiments, receiving mobile business location information indicative of the location of a mobile business includes receiving manual location updates indicative of a current location of the mobile business. For example, while traversing the route for the ice cream truck, the ice cream truck operator may periodically submit manual location updates that provide the current location of the ice cream truck. The location updates may be submitted via a mobile device, such as a mobile phone, that travels with the mobile business. For example, upon arriving at 100 Main St. at 1:15 pm, the ice cream truck operator may simply open a locating application (e.g., Google Latitude) on the operator's mobile phone, and submit a “check-in” for the ice cream truck business. Upon submitting the check-in, the location (e.g. geographic coordinates) of the mobile phone may be determined (e.g., via an integrated positioning device, such as a GPS device in the phone, triangulation using cellular-phone towers, or the like), and the determined location may be associated with the ice cream truck at the time of the check-in.

In some embodiments, receiving mobile business location information indicative of the location of a mobile business includes receiving automatic location updates indicative of a current location of the mobile business. For example, while traversing the route for the ice cream truck, the location of the ice cream truck may be tracked in real-time (e.g., tracking the ice cream truck's location at least hourly or more often) to provide the current location of the ice cream truck. Tracking may be accomplished via regular querying of the location a mobile device, such as a mobile phone, that travels with the mobile business. For example, a mobile phone of the operator of the ice cream truck may be queried (e.g., by a server) once per minute to track the location of the ice cream truck as it traverses its route. Thus, a 1:15 pm, 1:16 pm, 1:17 pm and so forth, the location (e.g. geographic coordinates) of the mobile phone may be determined (e.g., via an integrated positioning device, such as a GPS device in the phone, triangulation using cellular-phone towers, or the like) and the determined locations may be associated with the ice cream truck at each of the respective times. In some embodiments, the tracking may be effectuated by location updates initiated by a mobile device associated with the mobile business. For example, a locating application executing on the mobile phone of the ice cream truck operator may be employed to automatically send location updates (e.g., to a server) on a regular basis (e.g., once every five minutes). In some embodiments, the tracking may occur only during a given timeframe and/or at a specified interval. For example, the ice cream truck operator may specify that tracking of the ice cream truck take place during business hours (e.g., 8 am to 5 pm) and at a given interval (e.g., once every five minutes).

Method 100 may include updating an entity database to reflect the mobile business location information indicative of the location of the mobile business (block 104). In some embodiments, a database of entities includes entries for traditional businesses (e.g., brick and mortar businesses associated with a fixed/static location) as well as entries for mobile businesses (e.g., businesses associated with a variable location). The entries for traditional businesses may be associated with static location information that is indicative of one or more fixed locations (e.g., a given street address, a given set of geographic coordinates or the like), whereas entries for mobile businesses may be associated with a variable location information (e.g., predefined routes, dynamic location updates, such as check-ins/tracking, or the like) that is indicative of movement of the mobile business and/or is capable of being dynamically updated to reflect changes in location of the mobile business. Referring now to FIG. 2, which includes a table that illustrates an entity database storing mobile business location information in accordance with one more embodiments of the present invention, an entry corresponding to a mobile business may be may be associated with corresponding mobile location information, whereas entries corresponding to business or other entities having fixed locations may be associated with non-mobile location information. For example, the entries for “The Ice Cream Truck” and the “Airport Shuttle” are associated with mobile business location information “LI1” and “LI4,” respectively) that includes, or is at least based on mobile business location information, such as predefined routes, location updates (e.g., check-ins/tracking), or the like, for the respective businesses. Thus for example, where the operator provides route information for the ice cream truck, LI1 may include the route information. Where dynamic location updates are provided for the ice cream truck (e.g., via check-in, tracking, or the like), LI1 may include the location information associated with the dynamic updates (e.g., a time of the update and geographic coordinates indicative of a location of a mobile device associated with the mobile business at the time of the update). Table 200 may be updated dynamically as mobile business location information is received. Entries for business having a fixed location, such as “The Ice Cream Parlor” and “The Restaurant” are associated with non-mobile business location information “LI2” and “LI3,” respectively. Such information may include fixed locations (e.g., addresses or geographic coordinates associated with the businesses brick-and-mortar locations). Such non-mobile business location information may not be based on mobile business location information, such as predefined routes, location updates (e.g., check-ins/tracking), or the like, for the respective businesses.

As discussed herein, such mobile business location information may be used to identify, rank and/or display search results. For example, the location of mobile businesses may be determined at or near the time of a search query (based at least in part on the mobile business location information), and the determined locations may be used to rank the search results for the query.

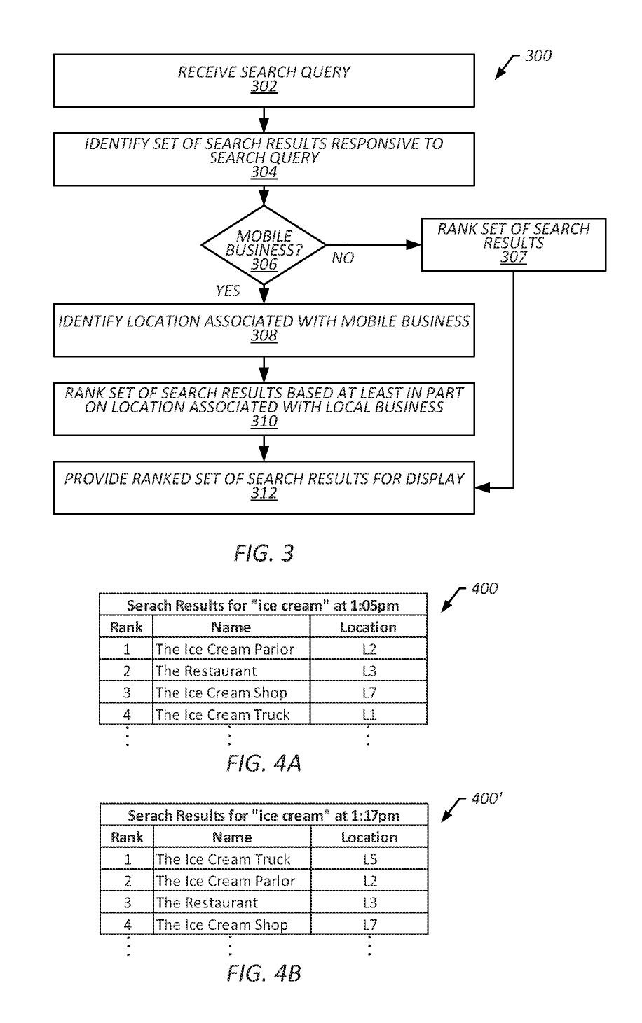

FIG. 3 is a flowchart that illustrates a method of servicing a search query 300 in accordance with one or more embodiments of the present invention. Method 300 may generally include receiving a search query, identifying a set of search results responsive to the search query, determining whether at least one of the search results identified correspond to a mobile business, and, in response to determining that at least one of the search results identified corresponds to a mobile business, identifying geographic locations associated with the mobile business, ranking the set of search results based on the determined locations and providing the ranked set of search results for display. Although certain embodiments are described with respect to a single mobile business of the search results for the purpose of illustration, it will be appreciated that such techniques can be used for search results including any number of mobile businesses.

Method 300 may include receiving a search query (block 302). In some embodiments, receiving a search query includes a search server receiving a search query submitted by a user. For example, a user may submit the search string “ice cream” via a search application, such as a free-text or map-based search webpage. The search query may be received by a search server that is tasked with servicing the search query.

Method 300 may include identifying a set of search results responsive to the search query (block 304). In some embodiments, identifying a set of search results responsive to the search query includes identifying a plurality of search results that are related to the search query. For example, the search server may identify the search results corresponding to “The Ice Cream Parlor,” “The Restaurant,” “The Ice Cream Shop”, “The Ice Cream Truck”, and so forth in response to the map-based search query for “ice cream”.

Method 300 may include determining whether at least one of the search results of the set of search results identified corresponds to a mobile business (block 306). It may be determined that at least one of the search results of the set of search results identified corresponds to a mobile business if at least one of the search results is identified as a mobile business and/or is associated with mobile business location information. For example, the search server may determine that the set of search results responsive to the map-based search query for “ice cream” includes a result for a mobile business based on the set of search results including the search result for “The Ice Cream Truck”. In some embodiments, in response to determining that the set of search results does not include a result corresponding to a mobile business, the process may proceed to ranking (block 307) and displaying the set of search results (block 312). For example, the search server may rank the set of search results based at least in part on fixed location information associated with some the search results of the set of search results, and serve a search results webpage, including the ranked set of search results, for display to the user.

Method 300 may include identifying a location associated with the mobile business in response to determining that the set of search results does include at least one result corresponding to a mobile business (block 308). In some embodiments, determining a location associated with the mobile business includes determining a location of the mobile business based at least in part on the mobile business location information currently associated with the mobile business. For example, the server may determine a location for the ice cream truck based on the mobile business location information LI1 that is currently associated with the ice cream truck. Where the mobile business location information includes route information for the mobile business, determining a location associated with the mobile business may include estimating or otherwise determining a location of the mobile business at or near the time of the search query based on the route information. For example, where the route information that indicates that the ice cream truck will be at 100 Main St. at 1:15 pm, at 200 Main St. at 1:20 pm, at 1100 2^{nd} St. at 1:25 pm and so forth, and the search query is received at 1:17 pm, the server may estimate the location of the ice cream truck as about half-way between 100 Main St. and 200 Main St. based on an interpolation of the specified locations of 100 Main St. at 1:15 pm and 200 Main St. at 1:20 pm. In some embodiments, the location is determined as the location specified as being visited immediately prior to the time of the query. For example, the server may determine the location of the ice cream truck to be 100 Main St. based on the query time of 1:17 pm. In some embodiments, the location is determined as the location to be visited immediately following the time of the query. For example, the server may determine the location of the ice cream truck to be 200 Main St. based on the query time of 1:17 pm. Further, a location for the mobile business may be determined based on one or more prior location updates. For example, where a location update is received at 1:15 pm that indicates the ice cream truck is located at 100 Main St., the server may determine the location of the ice cream truck to be 100 Main St. based on the most recent location update (i.e., the location update received immediately prior to the search query).

Method 300 may include ranking the set of search results based at least in part on the determined location (block 310). In some embodiments, ranking the set of search results may include ranking each of the search results relative to one another based on a plurality of factors, such as relevance to the search string, proximity of a location associated with the user to a location associated with the search result, and so forth. In some instances, ranking includes scoring the search results based on the various factors, and ranking the search results based on the scoring (e.g., a search results having a high score may be ranked/ordered above one or more other search results having a lower score and vice versa). Thus, for example, where ranking is based at least in part on a proximity of a location associated with the user to a location associated with the search result, a search result for a mobile business may experience a boost of its score/ranking when it is located proximate to the location associated with the user and/or may experience a decrease in score/ranking when it is not located proximate the location associated with the user.

FIGS. 4A and 4B are tables that illustrate ranked sets of search results in accordance with one or more embodiments of the present invention. FIG. 4A is a table that illustrates a first set of ranked search results for the search query “ice cream” submitted at or about 1:05 pm (e.g., when the ice cream truck is still far away from the user), and FIG. 4B is a table that illustrates a second set of ranked search results for the same search query submitted twelve minutes later (e.g., at or about 1:17 pm) (e.g., when the ice cream truck is close to the user). Locations “L1” and “L5” for the ice cream truck may be determined based on the mobile business location information “LI1” (see FIG. 2). Accordingly, where, for example, the location “L5” is closer than “L1” to a location associated with the user, the search result for the ice cream truck may receive a boost in score/ranking relative to the other search results as it approaches the location associated with the user. Moreover, as the ice cream truck moves away from the location associated with the user the search result for the ice cream truck may experience a decrease in its score/ranking relative to the other search results.

Method 300 may include providing the ranked set of search results for display (block 312). In some embodiments, providing the ranked set of search results for display includes serving the set of search results for display to the user. For example, upon identifying and ranking the search results, the server may generate a search results webpage, including a given number of the highest ranked search results of the set of search results 400 or 400′, and serving the search results page for display to the user. In some embodiments, the search results page may include a listing of the search results and/or a map having markers that correspond to locations of one or more of the search results.

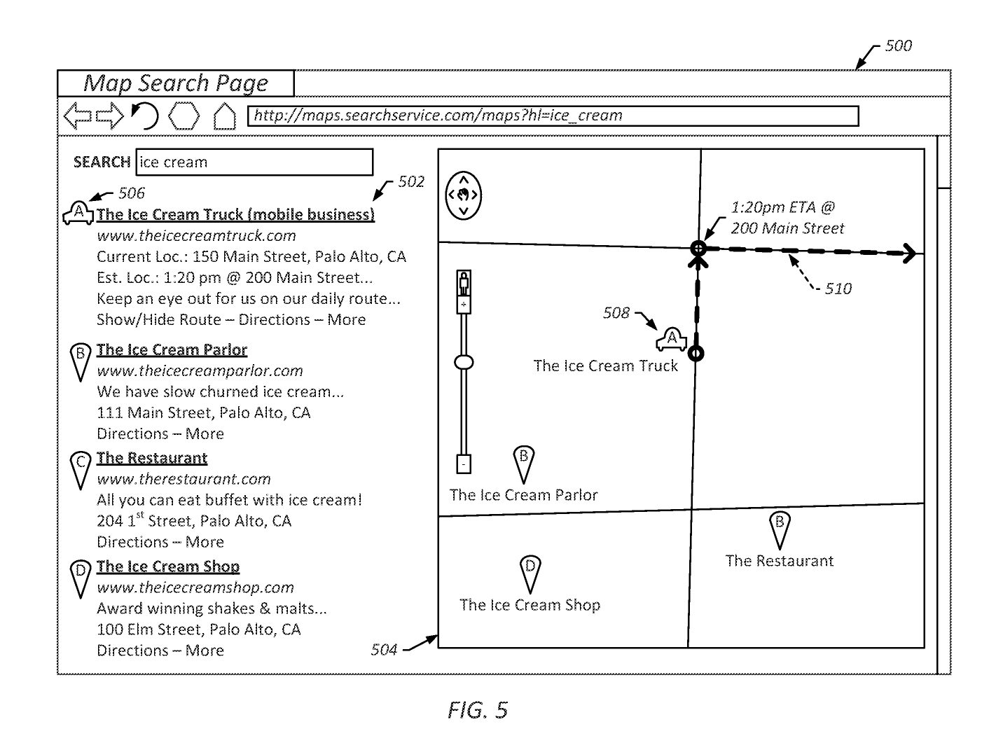

FIG. 5 illustrates a map-based search results webpage 500 in accordance with one or more embodiments of the present invention. Webpage 500 includes a listing of search results 502 that correspond to search results 400′ of FIG. 4B, as well as a map 504 having markers at locations corresponding to the respective search results. As depicted, the search result for the ice cream truck is accompanied by an icon (e.g., an icon depicting a car) 506 that is indicative of the search result being associated with a mobile business. Further, the map includes a mobile business location marker (e.g., an icon depicting a car) 508 at a location corresponding to the determined location of the ice cream truck (i.e., location L5) and an illustration of a route 510 that the ice cream truck is expected to follow based on route information provided by the ice cream truck operator. Expected route 510 may also include an indication of the approximate time at which the ice cream truck is expected to arrive at various locations along the route (e.g., 1:20 pm ETA @ 200 Main St.). A similar results webpage may be provided in response to the search query for “ice cream” submitted at 1:05 pm and corresponding to search results 400 of FIG. 4A. In that instance, the results webpage may include the search result for the ice cream truck lower in the listing of search results 502, and having icon 508 depicted at a location corresponding to location L1.

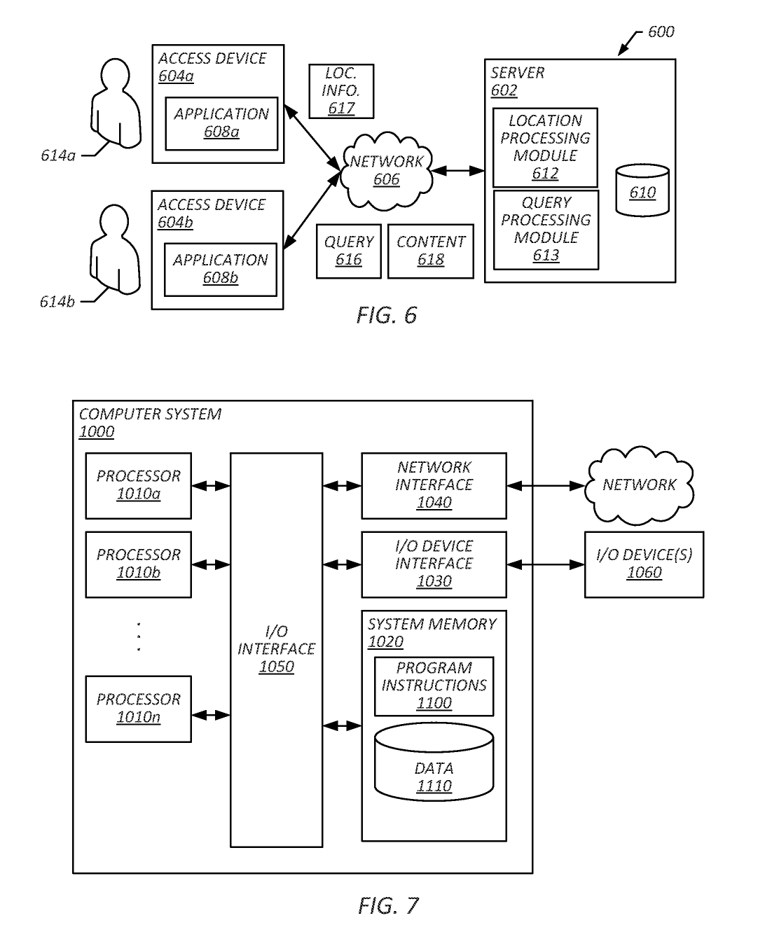

Methods 100 and 300 are exemplary embodiments of methods that may be employed in accordance with techniques described herein. Methods 100 and 300 may be may be modified to facilitate variations of its implementations and uses. Methods 100 and 300 may be implemented in software, hardware, or a combination thereof. Some or all of methods 100 and 300 may be implemented by one or more of the modules/applications described herein, such as location processing module 612, query processing module 613, application 608a and/or application 608b depicted and described in more detail below with regard to FIG. 6. For example, location processing module 612 may implement some or all of the steps described with regard to method 100 and/or query processing module 613 may implement some or all of the steps described with regard to method 300. The order of the steps of methods 100 and 300 may be changed, and various elements may be added, reordered, combined, omitted, modified, etc.

FIG. 6 is a block diagram that illustrates an exemplary query environment 600. Environment 600 includes a server 602 and access devices 604a and 604b communicatively coupled via a network 606.

Network 606 may include an electronic communications network, such as the Internet, a local area network (LAN), a wide area (WAN), a cellular communications network or the like. Network 606 may include a single network or combination of networks.

Access devices 604a and/or 604b (collectively referred to herein as access devices 604) may each include devices capable of communicating information via network 606. For example, access devices 604 may each include a personal computer (e.g., a desktop computer), a mobile computing device (e.g., a laptop or tablet computer), a cellular communication device (e.g., a cellular phone), a personal digital assistant (PDA), or the like. In some embodiments, each of access devices 604 is a client device of server 602. In some embodiments, each of access devices 604 includes various input/output (I/O) interfaces, such as a graphical user interface (e.g., display screen), an audible output user interface (e.g., speaker), an audible input user interface (e.g., microphone), a keyboard, a pointer/selection device (e.g., mouse, trackball, touchpad, touchscreen, stylus or the like), a printer, or the like. In some embodiments, each of access devices 604 includes general computing components and/or embedded systems optimized with specific components for performing specific tasks. In some embodiments, each of access devices 604 includes a computer system similar to that of computer system 1000 described below with regard to at least FIG. 7.

In some embodiments, access devices 604a and 604b include programs/applications 608a and 608b, respectively, that can be used to generate a request for content (e.g., a search query), to provide content, to render content, and/or to send request to and receive request from other devices (e.g., server 602) via network 606. For example, programs/applications 608a and 608b may include Internet browser applications that facilitate communication with server 602 and/or other entities of environment 600. In some embodiments, each of programs/applications 608a and 608b includes modules having program instructions that are executable by a computer system to perform some or all of the functionality described herein with regard to the respective access devices 604a and 604b.

Server 602 may include a network entity that serves requests by client entities, such as requests by access devices 604. Server 602 may host a content site, such as a website, a file transfer protocol (FTP) site, an Internet search website or other source of network content. In some embodiments, server 602 includes a search server (e.g., a search engine). In some embodiments, server 602 includes or otherwise has access to a datastore 610, such as a database or similar data repository. In some embodiments, server 602 includes a location processing module 612. In some embodiments, server 602 includes a query processing module 613. Location processing module 612 and/or query processing module 613 may include program instructions that are executable by a computer system to perform some or all of the functionality described herein with regard to a server. Location processing module 612 may include program instructions that are executable by a computer system to perform some or all of the steps of method 100. Query processing module 613 may include program instructions that are executable by a computer system to perform some or all of the steps of method 400. In some embodiments, server 602 includes a computer system similar to that of computer system 1000 described below with regard to at least FIG. 7. Although server 602 is represented by a single box in FIG. 6, server 602 may include a single server (or similar system), or a plurality of servers (and/or similar systems). For example, server 602 may include a plurality of different servers (and/or similar systems) that may be employed individually or in combination to perform some or all of the functionality described herein with regard to server 602.

In some embodiments environment 600 is used to employ techniques described herein. For example, a business operator 614a may submit mobile business location information (e.g., routes, location updates, etc.) 617 to server 602 using application 608a of access device 604a. Location processing module 612 may update entity information (e.g., table 200) stored in datastore 610 to reflect the received mobile business location information 617. Upon receiving a query 616 (e.g., map-based search query for “ice cream”) submitted by user 614a via application 608b of access device 604b, query processing module 613 may process the query (e.g., identify a ranked set of search results based at least in part on the entity information stored at datastore 610) and serve search results content 618 (e.g., search results webpage 500) to access device 604b. Application 608b may render content 618 for display to user 614b.

Exemplary Computer System

FIG. 7 is a block diagram that illustrates an exemplary computer system 1000. Various portions of systems and methods described herein, may include or be executed on one or more computer systems similar to system 1. For example, server 602 and/or access device 604 may include a configuration similar to at least a portion of computer system 1000. Further, methods/processes/modules described herein (e.g., location processing module 612, query processing module 613 and/or applications 608a and/or 608b) may be executed by one or more processing systems similar to that of computer system 1000.

Computer system 1000 may include one or more processors (e.g., processors 1010a-1010n) coupled to system memory 1020, an input/output I/O device interface 1030 and a network interface 1040 via an input/output (I/O) interface 1050. A processor may include a single processor device and/or a plurality of processor devices (e.g., distributed processors). A processor may be any suitable processor capable of executing/performing instructions. A processor may include a central processing unit (CPU) that carries out program instructions to perform the basic arithmetical, logical, and input/output operations of computer system 1000. A processor may include code (e.g., processor firmware, a protocol stack, a database management system, an operating system, or a combination thereof) that creates an execution environment for program instructions. A processor may include a programmable processor. A processor may include general and/or special purpose microprocessors. A processor may receive instructions and data from a memory (e.g., system memory 1020). Computer system 1000 may be a uni-processor system including one processor (e.g., processor 1010a), or a multi-processor system including any number of suitable processors (e.g., 1010a-1010n). Multiple processors may be employed to provide for parallel and/or sequential execution of one or more portions of the techniques described herein. Processes and logic flows described herein may be performed by one or more programmable processors executing one or more computer programs to perform functions by operating on input data and generating corresponding output. Processes and logic flows described herein may be performed by, and apparatus can also be implemented as, special purpose logic circuitry, e.g., an FPGA (field programmable gate array) or an ASIC (application specific integrated circuit). Computer system 1000 may include a computer system employing a plurality of computer systems (e.g., distributed computer systems) to implement various processing functions.

I/O device interface 1030 may provide an interface for connection of one or more I/O devices 1060 to computer system 1000. I/O devices may include any device that provides for receiving input (e.g., from a user) and/or providing output (e.g., to a user). I/O devices 1060 may include, for example, graphical user interface displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 and/or data 1110. Program instructions 1100 may be executable by a processor (e.g., one or more of processors 1010a-1010n) to implement one or more embodiments of the present technique. Instructions 1100 may include modules of computer program instructions for implementing one or more techniques described herein with regard to various processing modules. Program instructions may include a computer program (also known as a program, software, software application, script, or code). A computer program may be written in any form of programming language, including compiled or interpreted languages, or declarative/procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier. A tangible program carrier may include a propagated signal and/or a non-transitory computer readable storage medium. A propagated signal may include an artificially generated signal (e.g., a machine generated electrical, optical, or electromagnetic signal) having encoded information embedded therein. The propagated signal may be transmitted by a suitable transmitter device to and/or received by a suitable receiver device. A non-transitory computer readable storage medium may include a machine readable storage device, a machine readable storage substrate, a memory device, or any combination thereof, or the like. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium having program instructions stored thereon that are executable by a computer processor (e.g., one or more of processors 1010a-1010n) to cause some or all of the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 3020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices and/or software that may perform or otherwise provide for the performance of the techniques described herein. For example, computer system 1000 may include a desktop computer, a laptop computer, a tablet computer, a server device, a client device, a mobile telephone, a personal digital assistant (PDA), a mobile audio or video player, a game console, a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” may include a combination of two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

What is claimed is:

1. A computer-implemented method comprising:
receiving mobile business location information indicative of a geographic location of a mobile business;
receiving a search request;
identifying a set of search results responsive to the search request, the set of search results including a search result corresponding to the mobile business;
identifying a current geographic location of the mobile business based at least in part on the mobile business location information;
ranking the set of search results based at least in part on the current geographic location associated with the mobile business to generate a set of ranked search results; and
providing the set of ranked search results for display.

2. The method of claim 1, wherein receiving mobile business location information indicative of a geographic location of a mobile business comprises receiving route information indicative of a route traversed by the mobile business.

3. The method of claim 2, wherein the geographic location of the mobile business is estimated based on the route information.

4. The method of claim 1, wherein receiving mobile business location information indicative of a geographic location of a mobile business comprises receiving location updates.

5. The method of claim 4, wherein receiving location updates comprises receiving manual location updates submitted by an operator of the mobile business.

6. The method of claim 4, wherein receiving location updates comprises receiving automatic location updates.

7. The method of claim 5, wherein receiving location updates comprises receiving automatic location updates based on real-time tracking of the mobile business.

8. The method of claim 4, wherein the geographic location of the mobile business is determined to be a geographic location corresponding to a current location update received prior to the search query.

9. The method of claim 1, wherein ranking the set of search results based at least in part on the current geographic location associated with the mobile business comprises ranking the set of search results based on the proximity of locations corresponding to the search results to a location associated with the search request.

10. The method of claim 9, wherein the location associated with the search request comprises a location associated with a user that submits the search request.

11. The method of claim 9, wherein the location associated with the search request comprises a location associated with a mobile deice that is used to submit the search request.

12. The method of claim 1, further comprising:
receiving updated mobile business location information indicative of an updated geographic location of the mobile business;
receiving a second search request;
identifying a second set of search results responsive to the second search request, the second set of search results including a search result corresponding to the mobile business;
determining an updated current geographic location of the mobile business based at least in part on the updated mobile business location information;
ranking the second set of search results based at least in part on the updated geographic location associated with the mobile business to generate a second set of ranked search results; and
providing the second set of ranked search results for display.

13. The method of claim 1, wherein ranking the set of search results comprises:
identifying a geographic location corresponding to the search query; and
adjusting a ranking of the search result corresponding to the mobile business based on proximity of the current geographic location of the mobile business to the geographic location corresponding to the search query.

14. The method of claim 1, wherein providing for display of the set of ranked search results comprises displaying a map comprising an element indicating the geographic location of the mobile business.

15. The method of claim 1, wherein providing for display of the set of ranked search results comprises displaying a map comprising a route corresponding to a route of the mobile business.

16. The method of claim 1, wherein providing for display of the set of ranked search results comprises displaying a map comprising a marker at a given location, and an expected time of arrival of the mobile business at the given location.

17. The method of claim 1, wherein providing for display of the set of ranked search results comprises displaying a map comprising a marker indicative of a current location of the mobile business, a route corresponding to a route of the mobile business, a marker at a given location on the route, and an expected time of arrival of the mobile business at the given location.

18. The method of claim 1, wherein providing for display of the set of ranked search results comprises providing a visual indication that the search result corresponding to the mobile business corresponds to a mobile business.

19. A system comprising:
one or more memories storing instructions; and
one or more processors coupled to the one or more memories and configured to execute the instructions stored thereon to perform the following steps:
receiving mobile business location information indicative of a geographic location of a mobile business;
receiving a search request;
identifying a set of search results responsive to the search request, the set of search results including a search result corresponding to the mobile business;
identifying a current geographic location of the mobile business based at least in part on the mobile business location information;
ranking the set of search results based at least in part on the current geographic location associated with the mobile business to generate a set of ranked search results; and
providing the set of ranked search results for display.

20. A non-transitory computer readable medium comprising program instructions stored thereon that are executable by a processor to cause the following steps:
receiving mobile business location information indicative of a geographic location of a mobile business;
receiving a search request;
identifying a set of search results responsive to the search request, the set of search results including a search result corresponding to the mobile business;
identifying a current geographic location of the mobile business based at least in part on the mobile business location information;
ranking the set of search results based at least in part on the current geographic location associated with the mobile business to generate a set of ranked search results; and
providing the set of ranked search results for display.
